(19) United States
(12) Patent Application Publication
(10) Pub. No.: US 2017/0028601 A1
(43) Pub. Date: Feb. 2, 2017

(54) METHOD OF MAKING A COMPOSITE PREFORM

(71) Applicant: SABIC Global Technologies B.V., Bergen op Zoom (NL)

(72) Inventors: Ranvir Kumar Soni, Pittsfield, MA (US); Peter James Zuber, Pittsfield, MA (US)

(21) Appl. No.: 15/302,583

(22) PCT Filed: Apr. 6, 2015
(86) PCT No.: PCT/US2015/024518

§ 371 Date: Oct. 7, 2016

Related U.S. Application Data
(60) Provisional application No. 61/976,856, filed on Apr. 8, 2014.

(51) Int. Cl. B29C 45/14; B29B 11/04; B29C 65/48; B29C 65/62; B29C 65/08

(52) U.S. Cl. CPC B29C 45/1418; B29C 65/62; B29C 65/08; B29C 65/48; B29B 11/04; B29C 2045/14245; B29K 2101/12

(57) ABSTRACT

A method to form a part can comprise forming a pattern with a commingled yarn (10), wherein the commingled yarn comprises thermoplastic resin filaments (40) formed from a thermoplastic material and reinforcing filaments (20) formed from a reinforcing material, and wherein the reinforcing material has a glass transition temperature and/or a decomposition temperature that is higher than a glass transition temperature of the thermoplastic material; attaching the pattern to a carrier material (76) to form a preform (70); and using the preform to form a part.

### BACKGROUND

Fiber reinforced plastic composite materials can offer equivalent or improved structural properties at a lower weight than conventional materials. For applications requiring high strength to weight ratios, (e.g., aerospace, automotive, construction, marine, medical, and prosthetic applications), these materials are increasingly being used. Fiber reinforced plastic materials can include reinforcing filament, embedded within a plastic resin matrix. Thermoplastic composite parts can be produced, amongst other methods, by molding thermoplastic resin into a mold holding a reinforcing filament preform. These preforms can be constructed from reinforcing filament sheets or mats.

In a fiber sheet the reinforcing filaments can have a fixed orientation relative to one another. A reinforcing filament mat can have random fiber orientation.

Reinforcing filament sheets and mats can be used in the fabrication of parts of varying shapes and sizes. However, part fabrication using these sheets and mats can include time consuming, manual, hand layering of sheets (layup). Labor intensive hand layup processes can be automated, but automation can require significant investment. Sheets and mats can restrict a manufacturer's ability to orient and/or position the reinforcing filaments within a part. Additionally, the formation of features, such as holes and the like, can require cutting of the reinforcing filaments.

To improve the strength to weight ratio of these composite parts, it is desirable to improve or maximize the number of reinforcing filaments that are substantially aligned with the direction of a force flux which will act on the finished part. Reinforcing filaments can offer high tensile strength. As such, substantially aligning the fiber direction parallel to the applied tensile stress can improve tensile strength of the composite part in comparison to parts with fiber aligned otherwise. It can also be beneficial to reduce or minimize discontinuities of the reinforcing filaments within a composite part, (i.e., terminations from fiber breakage, cutting, and the like) which can reduce the strength of the part and cause local defects within the part leading to part failures.

### SUMMARY

The present inventors have recognized, among other things, that a problem to be solved can include reducing the time and/or cost to manufacture composite parts, improving the ability to orient reinforcing filaments within a composite part, and providing a way to retain continuous reinforcing filaments while forming features, such as holes and the like, in a composite part. The present subject matter can help provide a solution to this problem, such as by providing a method of forming a composite part using a yarn having filaments of thermoplastic material and reinforcing filament material in a tailored fiber placement process.

Disclosed herein are thermoplastic composite preforms, thermoplastic composite parts, and methods of making the same.

In an embodiment, a method to form a part can comprise: forming a pattern with a commingled yarn, wherein the commingled yarn comprises thermoplastic resin filaments formed from a thermoplastic material and reinforcing filaments formed from a reinforcing material, and wherein the reinforcing material has a glass transition temperature or a decomposition temperature that is higher than a glass transition temperature of the thermoplastic material; attaching the pattern to a carrier material to form a preform; and using the preform to form a part.

In an embodiment, a composite part can comprise: a pattern of reinforcing filaments, wherein, when in use, the part has a force flux, and wherein the reinforcing filaments are aligned with the force flux; and a thermoplastic resin matrix; wherein the reinforcing filaments are formed of a reinforcing material different from a thermoplastic material of the thermoplastic resin matrix, wherein the reinforcing filaments are stiffer and of a higher tensile strength than the thermoplastic resin matrix, and wherein the thermoplastic resin matrix is bonded to the reinforcing filaments.

In an embodiment, a composite preform can comprise: a carrier material; and a commingled yarn; wherein the commingled yarn comprises thermoplastic resin filaments formed from a thermoplastic material and reinforcing filaments formed from a reinforcing material; wherein the reinforcing filaments are stiffer and have a higher tensile strength than the thermoplastic resin filaments; and wherein the commingled yarn is attached to the carrier material in a pattern.

This summary is intended to provide a summary of subject matter of the present patent application. It is not intended to provide an exclusive or exhaustive explanation of the invention. The detailed description is included to provide further information about the present patent application.

### BRIEF DESCRIPTION OF THE DRAWINGS

Refer now to the figures, which are exemplary embodiments, and wherein the like elements are numbered alike.

FIG. 1 is an illustration of a commingled yarn.

FIG. 2 is an illustration of a cross-sectional view along A-A of the commingled yarn of FIG. 1.

FIG. 3 is a photograph of a commingled yarn preform made using a Tailored Fiber Placement (TFP) process.

FIG. 4 is an exploded view of section 100 of the photograph of FIG. 3 showing the edge of the commingled yarn preform.

The figures are exemplary only and are not drawn to a particular scale.

### DETAILED DESCRIPTION

Fabrics of reinforcing fibers (hereinafter referred to as reinforcing filaments) can be of woven, knitted, braided, or stitched construction. The reinforcing filaments of these fabrics can crisscross one another in a fixed orientation (e.g., perpendicularly) within the plane of the fabric. Such a construction can be similar to other textiles. Shapes cut from these sheets can be layered with resin sheets or films to create a composite part preform that can be consolidated, e.g., can be laminated. When parts are produced in this way, the length of individual filaments can be oriented relative to the shape of the part. As a result the reinforcing filaments can be non-optimally aligned with the flux of forces acting on the finished part. For example, reinforcing filaments running parallel to the length, or longest dimension, of the part can be longer than fibers running parallel to the width of the part. When constructed in this way, thicker, it may be that heavier parts are needed to meet the structural demands of a given application, because the reinforcing filaments are not positioned within the part in a way to provide desired strength.

A method to fabricate composites can be to stitch together reinforcing filaments to create a reinforcing filament preform. Preforms fabricated as such can be stitched to maintain the preform shape (and net shape of resultant parts), and to control the ratio of resin to reinforcing material in the finished part to a desired ratio. These preforms can improve the reinforcing filament placement relative to other methods, but it can be difficult to disperse the resin matrix into a tightly stitched reinforcing filament preform constructed in this way. For example, the reinforcing filaments in such a tightly stitched preform can abut one another and can prevent thermoplastic resin from penetrating the preform and encapsulating the reinforcing filaments during consolidated. Loosening the stitching can render the preform unusable as the reinforcing filaments can become too distant from one another.

Tailored Fiber Placement (TFP) processes using commingled yarn can be used to overcome these deficiencies. A TFP process can include forming a pattern using commingled yarn and attaching it to a carrier material to form a preform. Optionally one or more preforms can further be processed, e.g., molded such as injection molded, compression molded, overmolded, and the like, to form an article. A commingled yarn can allow for more specific orientation of individual reinforcing filaments within a thermoplastic composite part, such as a preform. The commingled yarn can include filaments of thermoplastic resin and reinforcing filaments. The commingled yarn can consist of filaments of thermoplastic resin and reinforcing filaments. A part constructed of commingled yarn can be tightly stitched without increasing the difficulty of dispersing the resin matrix, since the thermoplastic resin material is pre-dispersed in the part. In TFP, a reinforcing filament pattern can be attached to a base, or carrier material, using one or more fixing/attaching threads. The fixing threads can hold the reinforcing filaments in place during part fabrication such as thermosetting or thermoforming.

A factor that can affect the strength of a composite part can be how extensively the polymer resin matrix is able to bond to the reinforcing filament throughout the part. The extent that the resin matrix is able to saturate, surround, and bond to the reinforcing filaments is called “wet out” of the reinforcing filaments. If the reinforcing filaments do not sufficiently wet out during consolidation, then adhesion between the fibers and the resin matrix can be poor and parts can be more likely to fail.

A commingled yarn part made using TFP can sufficiently wet out the reinforcing filaments (i.e., resulting in acceptable structural characteristics of the finished part) at a lower consolidation temperature and/or pressure in comparison to parts constructed in other ways. This can reduce energy consumption during manufacturing. A commingled yarn part made using TFP can sufficiently wet out the reinforcing filaments in less time in comparison to parts constructed in other ways. This can reduce manufacturing cycle time.

Commingled thermoplastic yarns can include thermoplastic resin filaments and reinforcing filaments. Such filaments can lie adjacent to one another, occasionally abutting one another. The filaments can be dispersed individually throughout the yarn. The filaments can be dispersed in bundles throughout the commingled yarn. Bundles can include filaments of thermoplastic material, filaments of reinforcing material, or a combination comprising at least one of the foregoing. As used herein bundle can refer to a grouping of more than one filament of the same material or a grouping of more than one filament of different materials.

The commingled yarn can be attached to a carrier material in a Tailored Fiber Placement (TFP) process, to fabricate near net shaped reinforcing filament preforms that have substantially aligned reinforcing filaments. By using a TFP process, the commingled yarns can be attached onto a carrier material in a specific pattern and can substantially align the orientation of reinforcing filaments within the composite part. Where “substantially”, as in “substantially align”, can include variations due to the undulating nature of sewing a yarn, can allow for turning direction to create multiple passes throughout a pattern, can allow for turning direction of yarn to build up width or thickness of a part, and/or can allow for natural splaying of reinforcing filaments. Substantial alignment can include patterns where 60% or more (specifically, 80% or more) of the filaments in the pattern are oriented along (e.g., parallel to) a steady state force flux which may act in one or more directions within the part. The reinforcing filaments can be aligned, and specifically oriented relative to the stress encountered when the finished composite part is in use. In addition, the use of a TFP process can allow for the formation of features (e.g., holes, thin cross sections, and the like) in the composite part. These features can be formed into the part using substantially continuous yarns of commingled filaments during the TFP process. Where “substantially” as in “substantially continuous” can account for terminations of yarn due to changing yarn spools during a stitching operation and for stretch broken filaments where filaments of the yarn are broken into specific lengths prior to construction of the yarn. Whereas, when these features are formed into laminated parts the reinforcing filaments can be severed (e.g., cut, punched, drilled, machined, and the like), creating discontinuities in the reinforcing filaments that can reduce the strength of the finished composite part. Additional processing to create these features can result in higher manufacturing cost. Additional processing to create these features can result in longer manufacturing cycle time.

Commingled yarns can be produced in a variety of ways. Tows (e.g., untwisted bundles of filaments) of reinforcing filaments and thermoplastic resin filaments can be formed into a commingled yarn, by air entanglement, which interlaces the filament bundles. Tows of reinforcing filaments and thermoplastic resin filaments can be twisted, spun, wrapped, mechanically intertwined, or a combination comprising at least one of the foregoing to form a commingled yarn, for example, as can be done in rope-making. Commingled yarn can include stretch broken filaments, where the individual filaments have a specific length that is shorter than the length of the yarn. Commingled yarn can include a wrapping filament that wrap around another filament. Commingled yarn can include wrapping filaments that wrap around other filaments. Wrapping filaments can include reinforcing filaments, thermoplastic resin filaments, or a combination comprising at least one of the foregoing.

In commingled yarns, the thermoplastic resin filaments and reinforcing filaments can be randomly distributed, e.g., the location the filaments throughout the cross-sectional area of the yarn (area of a cross-section of the yarn taken along a t-x plane in the attached figures) is not predetermined or particularly selected, the location of the filaments can be the result of the manufacturing process of the yarn. The thermoplastic resin filaments can be uniformly distributed throughout the cross-sectional area of the yarn, e.g., the thermoplastic resin filaments can be evenly spaced apart from one another throughout the cross-sectional area of the yarn where the distance between any two thermoplastic resin filaments is constant throughout the cross-sectional area of the yarn. The thermoplastic resin filaments can be particularly distributed throughout the cross-sectional area of the yarn, e.g., non-random where the location of thermoplastic resin filaments can be selected or predetermined during manufacturing of the yarn. A particular yarn distribution can be used to fine tune thermoplastic flow throughout a composite part during consolidation. The reinforcing filaments can be in abutting contact with the thermoplastic resin filaments throughout the yarn. The cross-sectional distribution, (distribution throughout cross-sectional area of the yarn, in the t-x plane) of resin filaments and reinforcing filaments, can vary throughout the length of the commingled yarn as measured in the 1-axis direction.

The reinforcing filaments can be stiffer than the thermoplastic resin filaments. The reinforcing filaments can have a higher tensile strength (e.g., tenacity) than the thermoplastic resin filaments. The reinforcing filaments within commingled yarns can include carbon fiber, glass fiber, aramid fiber, basalt fiber, quartz fiber, boron fiber, cellulose fiber, natural fiber, liquid crystal polymer fiber, high tenacity polymer fiber (e.g., polypropylene, polyethylene, poly(hexano-6-lactam), poly[imino(1,6-dioxohexamethylene) imnohexamethylene]), or a combination of at least one of the foregoing.

The thermoplastic resin fiber filaments can include polycarbonates, polyetherimides, polyetheretherketones (PEEK), polyetherketoneketone (PEKK), polyetherketone (PEK), polypropylenes, polyethylenes, including polytetrafluoroethylene (PTFE), polystyrenes, polyvinyls, including polyvinyl chlorides (PVC), polyethylene terephthalates, polybutylene terephthalates (PBT), polyoxymethylene (POM), poly(p-phenylene ether) (PPE), acetals, acrylics, nylons, thermoplastic polyurethanes, polyacetals, polyphenylene sulfides, cycloolefins, thermotropic polyesters, acrylonitrile butadiene styrene (ABS), an ionomer thereof, a copolymer thereof, or a combination comprising at least one of the foregoing.

The commingled yarns can include a mixture of thermoplastic resin filaments and reinforcing filaments. A commingled yarn can include a total of 2 to 100,000 filaments, for example, 1,000 to 50,000 filaments, or, 3,000 to 50,000 filaments.

A reinforcing filament can have a thickness of 1 micrometer (μm) to 50 μm (as measured along the longest linear dimension spanning the cross-section of the filament in the t-x plane in the attached figures), for example, 2 μm to 10 μm, or, 5 μm to 10 μm.

A thermoplastic resin filament can have a thickness of 1 μm to 50 μm (as measured along the longest linear dimension spanning the cross-section of the filament in the t-x plane in the attached figures), for example, 2 μm to 25 μm, or, 5 μm to 25 μm.

A commingled yarn can have a thickness of 0.1 mm to 20 mm (as measured along the longest linear dimension spanning the cross-section of the yarn in the t-x plane in the attached Figures), for example, 0.1 mm to 2 mm, or, 0.1 mm to 1 mm.

The thermoplastic resin filaments and reinforcing filaments can have any cross-sectional shape along their length (as measured along the 1-axis direction in the attached Figures). As used herein, cross-sectional shape can refer to the perimeter shape in a t-x plane of the attached Figures. The cross-sectional shape of a filament can change along the length of the filament. For example, the cross-sectional shape of a thermoplastic resin and/or a reinforcing filament can be circular, oval, or any simple closed polygonal shape (e.g., cyclic, equiangular, equilateral, tangential, and rectilinear polygons, further including triangular, quadrangular, pentagonal, hexagonal, heptagonal, octagonal, star shaped, and the like) with straight or curved edges.

Similarly, a bundle of filaments can have any cross-sectional shape. Void space can be formed between filaments within the bundle, due at least in part, to the cross-sectional shapes of the individual filaments, which combine to form a bundle. For example, the cross-sectional shape of a thermoplastic resin or reinforcing filament bundle can be circular, oval, or any simple closed polygonal shape (e.g., cyclic, equiangular, equilateral, tangential, and rectilinear polygons, further including triangular, quadrangular, pentagonal, hexagonal, heptagonal, octagonal, star shaped, and the like) with straight or curved edges.

The commingled yarn can have any cross-sectional shape. Void space can be formed between filaments within the commingled yarn, due at least in part, to the cross-sectional shapes of the individual filaments, which combine to form the commingled yarn. For example, the cross-sectional shape of a commingled yarn can be circular, oval, or any simple closed polygonal shape (e.g., cyclic, equiangular, equilateral, tangential, and rectilinear polygons, further including triangular, quadrangular, pentagonal, hexagonal, heptagonal, octagonal, star shaped, and the like) with straight or curved edges.

The commingled yarn can have 5 wt % (weight percent) to 95 wt % reinforcing filament material, for example, 40 wt % to 60 wt %, or, 50 wt % reinforcing filament material, where the balance of the yarn can be thermoplastic resin material. For example, the yarn can be made of 50 wt % reinforcing filaments, and 50 wt % thermoplastic resin filaments. The reinforcing filament material can have a lower specific density (weight per unit volume) than the thermoplastic resin which can result in higher volume fractions of reinforcing material in the commingled yarn, when the weight percentages of the reinforcing material and thermoplastic material are equal.

In a TFP process, a commingled yarn roving can be attached to a carrier material to hold the yarn in place as the part is formed. The carrier material can include thermoplastic resin, reinforcing filament or a combination including at least one of the foregoing. The carrier material can be a film, woven or nonwoven sheet, a matrix-compatible foil, and the like. A thermoplastic resin used as a carrier material can be the same thermoplastic resin of the commingled yarn. A thermoplastic resin used as a carrier material can be a different thermoplastic resin than the thermoplastic resin of the commingled yarn. A carrier material having the same thermoplastic resin as the commingled yarn can eliminate compatibility issues associated with different resins. A carrier material having the same thermoplastic resin as the resin matrix of the composite part can eliminate compatibility issues associated with different resins, such as processing temperature, chemical compatibility, decomposition temperature, other physical properties, and the like.

A TFP process can be used to attach a commingled yarn to a carrier material (i.e., base material, or backing material) in a pattern by sewing, as in stitching or embroidering, the yarn directly onto the carrier material to form a preform. In forming the preform, the commingled yarn can be attached to a carrier material with a separate fixing, or holding, thread. In forming the preform, the commingled yarn can be attached to a carrier material without a separate fixing, or holding, thread. A stitching operation, for stitching commingled yarns directly to a carrier layer, can be performed by embroidering machines. A stitching operation, for stitching commingled yarns directly to a carrier material, can be performed by sewing machines. A commingled yarn can be stitched directly to a carrier material with a single stitching head.

The commingled yarn can be attached to a carrier material, at least in portions of the preform, by using a separate fixing thread. A separate thread can be made of a thermoplastic resin or reinforcing filament. A separate thermoplastic thread can be used to augment the amount of plastic in specific areas of the part. A separate fixing thread can help to achieve the desired plastic flow when the part is consolidated. A separate fixing thread can help to achieve a specific ratio of thermoplastic to reinforcing filaments in a selected location of a part. A separate fixing thread can be used to adjust resin flow during consolidation, such that the reinforcing filaments are sufficiently wet out to achieve the desired properties of the composite part.

The commingled yarn can be attached to a carrier material by, holding the yarn in place periodically by spot-melting the yarn, such as with a laser, with an ultrasonic welder or by using heat-staking. Commingled yarns can also be attached to other commingled yarn already attached to the carrier material in a similar fashion, e.g., via sewing, spot-melting, ultrasonic welding, adhesive deposition, heat-staking, or a combination. In this way, the preform can be built-up, increasing the thickness in a direction perpendicular to the surface of the carrier material. When the preform is built up with more than one layer of commingled yarn, the thickness of the preform (perpendicular the surface of the carrier material) can be less than or equal to 50 mm, for example, 1 mm to 15 mm, or, 1 mm to 8 mm, without compromising the integrity of the commingled fibers (e.g., without breaking filaments within the commingled yarn).

The preform pattern can be chosen such that the direction of the reinforcing filaments can be substantially aligned with one another. The preform pattern can be selected such that the reinforcing filaments can be substantially aligned parallel to a selected force flux for example, a steady state force flux that is expected to be applied to the finished part such as when the part is in use. Once the commingled yarn pattern is attached to a carrier material, any amount of excess carrier material can be removed by a cutting operation. In this case, the cutting operation does not require cutting of the reinforcing filaments, which have been attached to the carrier material as a substantially continuous yarn. Preforms formed in this manner can be fabricated in a single stitching operation. Resin films can be laid down over, under, or between the commingled yarn layers. The thickness of the part can be further increased by layering (e.g., with commingled yarn, resin sheets or films, reinforcing filament sheets, and the like), or folding the preform, to achieve the desired thickness. A layered or folded preform can be secured periodically to hold a desired shape by sewing, spot-melting, ultrasonic welding or heat-staking. A commingled yarn preform can be layered with other correspondingly shaped preforms. A commingled yarn preform can be layered with resin sheets or films. A commingled yarn preform can be sandwiched by resin sheets or films. These additional layers can have a shape corresponding to the shape of the commingled yarn preform. Additional layers can build-up the part to a desired thickness. Additional layers can provide extra thermoplastic resin to aid in wetting up the part during consolidation.

The composite part can be consolidated by a conventional compaction/compression method with heating where the resin is softened and/or melted to form the resin matrix which encapsulates and bonds to the reinforcing filaments.

Commingled yarn preforms made using the TFP processes can reduce the processing cost, processing cycle time, and can increase composite part strength, but there are several notable challenges in realizing these benefits. In a TFP process a thermoplastic fixing thread can be used to attach a pure reinforcing filament roving to a carrier material. This allows flexibility in selecting the amount and the location of thermoplastic material within the preform through selection of the size, shape, and placement of the thermoplastic thread. Whereas the size and shape of the thermoplastic resin filaments within a commingled yarn are pre-determined.

Fixing thread(s) can include thermoplastic resin filaments, reinforcing filaments, or a combination comprising at least one of the foregoing. Fixing threads can be used to influence the amount of thermoplastic material in selected areas. The number of fixing thread stitches along the length of the roving can be adjusted, as in increased or decreased, to achieve the desired ratio of thermoplastic to reinforcing filament in areas of the preform. The preform can be provided with additional fixing threads of thermoplastic resin in areas of the preform where higher thermoplastic resin flow is desired during consolidation, or the number of thermoplastic fixing threads reduced in areas where lower resin flow is desired. A fixing thread of reinforcing filaments can be used to provide resistance to interlaminar shear stress.

However, in attaching a commingled yarn roving directly to a carrier material, i.e. without additional fixing thread, the location and amount of thermoplastic resin, and the ratio of thermoplastic to reinforcing filaments, is pre-determined by the shape, thickness, and distribution of thermoplastic resin filaments within the commingled yarn. To overcome this drawback, additional thermoplastic resin can be incorporated into the preform by changing the amount and/or distribution of the thermoplastic resin filaments, or reinforcing filaments, within the commingled yarn.

The amount and/or distribution of thermoplastic resin or of reinforcing filament, in a commingled yarn can be adjusted by changing the shape or thickness of individual filaments, by changing the number of individual filaments per cross-sectional area of commingled yarn, and/or by changing the location of filaments within the cross-sectional area of the yarn. Adjusting the material distribution in the commingled yarn can resolve issues that occur globally, across the entire part.

To address discrete, localized, areas of insufficient resin one can add commingled yarn (e.g., bunch commingled yarn in areas where more thermoplastic resin is desired), and/or add thermoplastic material to the preform. These measures can provide additional resin in particular areas of the part and increase thermoplastic resin flow locally during consolidation. Commingled yarn can be added, e.g., bunched, by increasing the number of stitches to the carrier material and/or by using a thermoplastic thread or reinforcing filament thread to attach additional commingled yarn in the desired areas. Additional thermoplastic material can be attached to the preform in the same ways that the commingled yarn can be attached, e.g., direct stitching, spot-melting, such as with a laser, ultrasonic welding and/or heat-staking. Additional thermoplastic material can include, for example, thermoplastic resin filaments, threads, yarns, films, woven or non-woven sheets, and the like.

A fixing thread can include thermoplastic resin material or reinforcing filament material, and can be used to attach the commingled yarn to the carrier material in a pattern. In this way the commingled yarn can be held to the carrier material by the fixing thread. This can be done throughout the entire preform, or can be done locally within discrete areas of the preform, to adjust the ratio of reinforcing material to resin material and to achieve the desired resin flow during consolidation.

A fixing thread of thermoplastic resin material can be made of the same thermoplastic resin material that will ultimately combine with the thermoplastic resin matrix of the composite part during consolidation. A fixing thread can be made of a material that can be removed physically, mechanically, thermally, or chemically prior to or during subsequent consolidation and/or compaction processes.

It was found that the pre-distributed thermoplastic resin of a commingled yarn could sufficiently wet out the reinforcing filaments (such as to meet functional requirements of the composite part, e.g., structural requirements). Thus wet out could be achieved without particular design consideration of resin flow in the part during consolidation. Using commingled yarns can provide adequate thermoplastic resin throughout the part, such that there was no need to add thermoplastic material to a commingled yarn preform. The wet out during consolidation can be improved by using commingled yarn, in comparison to parts made by other methods.

Despite the expected challenges and potential drawbacks, it was found that design flexibility can be improved by the use of commingled yarn in composite preforms. These improvements can be attributed to the close proximity and pre-distribution of resin filaments between reinforcing filaments within the commingled yarn roving.

During consolidation the molten resin does not need to penetrate a tightly woven reinforcing filament preform or a bundle of reinforcing filaments since the resin filaments are already distributed throughout the preform and within the reinforcing filaments. As a result, during consolidation the viscosity of the molten resin does not need to be as low, and the average travel distance of resin material (average distance the resin must travel to wet out the reinforcing filaments) is reduced compared to preforms constructed without commingled yarn. Thus, the consolidation stage for forming parts with commingled yarn can be faster, performed with lower pressure, and/or performed at lower temperature relative to parts made from other methods (e.g., lamination, TFP processes using resin fixing threads and rovings of reinforcing filament).

A TFP process can also be used to form shapes (e.g., circles, ovals, or simple polygons of straight of curved sides) in the pattern of the preform. The reinforcing filaments can be continuous, or uncut in forming these features. For example, a TFP process can be used to attach the commingled yarn onto a carrier material in the pattern of a shape. The interior area of the shape can be free of commingled yarn. The interior area of the shape can be empty, i.e. void of commingled yarn and carrier material, or can include only the carrier material. The perimeter of the shape can be formed from continuous commingled yarn disposed about the perimeter of the shape. The carrier material on the interior of the shape can then be cut from the preform to create a hole through the preform. The cutting can be done before or after the preform is consolidated into a composite part. In either case, the shape can form a hole through the finished composite part.

In other words, the composite preform can include a hole, or a portion configured to create a hole. The hole can be formed by reinforcing filaments that are oriented tangentially around the perimeter of the hole. The hole can be formed by continuous commingled yarn disposed along the perimeter of the hole. Once the composite part is consolidated and after any post-consolidation processes are completed the composite part can include a hole where the reinforcing filaments are disposed, uncut, along the perimeter of the hole, and the thermoplastic material forms a continuous matrix encapsulating the reinforcing filaments.

In contrast, a hole can be cut, punched, machined, or the like through the woven reinforcing filaments of preforms made from one or more sheets of reinforcing filaments (e.g., lamination). The cutting operation can be performed directly on the preform before consolidation or on the composite part after the composite part is consolidated (e.g., after molding). Irrespective of when, or how, a hole is cut, a hole cut through a part in this manner can sever the reinforcing filaments of the preform. This can result in discontinuities in the fiber structure within the preform and reduce the ability to transmit stress or mechanical load through the part. This reduces the strength of a finished composite part constructed in this way.

Strength of a composite part made from commingled yarn can come from the continuous placement, and substantial alignment, of commingled yarn, in particular the reinforcing filaments, throughout the volume of the preform. The commingled yarn can be formed in a pattern. The pattern can include a plurality of reinforcing filaments grouped together and a major dimension (e.g., the length) of the reinforcing filaments in the group can be oriented along a common path. The common path can be aligned with features of the pattern, e.g. edges, holes, ribs, and the like. The common path can be aligned with a direction of a force flux when the part is in use.

Accordingly, a composite part made of commingled yarn can experience minimal, or no, reduction in strength, when the carrier material is removed to create holes, as previously described. Although a reinforcing filament material can be used as the carrier material, its contribution to part strength can be less than the strength provided by the reinforcing filaments of the commingled yarn, as its purpose is to support the commingled yarn while the composite part preform is being formed.

Once the preform is complete the composite part can be consolidated using a compaction/compression processes, e.g., molding. For example, the fiber preform (and additional layers if present) can be placed into a mold having a shape complimenting the shape of the fiber preform or corresponding to the shape of the finished composite part. The preform can then be heated to a specified temperature to reduce the viscosity of the resin within the preform. Once the temperature reaches the glass transition temperature, or melting temperature, of the thermoplastic resin, the thermoplastic resin begins to soften, melt, and move.

The softened polymer resin moves, or flows, into voids between reinforcing filaments within the preform and thus surrounds and bonds to the surfaces of the reinforcing filaments. In this way, the composite includes reinforcing filaments encapsulated in a thermoplastic resin matrix. The preform can be compacted, e.g., pressed, to a specified pressure to squeeze out air that may be entrapped in the part, thus eliminating void space. The pressure and temperature of the preform can be maintained for a selected time, at least in part, to ensure sufficient saturation and bonding of the resin to the reinforcing filaments and part integration. The preform temperature can then be reduced while the compaction pressure is maintained to hold the shape of the final part as the thermoplastic resin cools and solidifies. Once the preform temperature is reduced below the glass transition temperature, or melting temperature, of the thermoplastic resin, the part can be removed or ejected from the compaction device, e.g., mold, and the part can be cooled to room temperature.

Once the composite part has been formed, the part can be processed post-consolidation, or finish-processed, to form a finished composite part. Post-consolidation processing operations can include removing material from the part, and/or reforming the part chemically, mechanically, and/or thermally, for example, post-consolidation processing can include abrasive blasting, breaking, buffing, burnishing, cutting, drilling, etching, eroding, grinding, indenting, machining, marking, polishing, sanding, scoring, shaping, threading, trimming, tumbling, vibrating, and/or otherwise creating surface treatments, or a combination including at least one of the foregoing. Post-consolidation processing operations can include adding material to the part, for example, post-consolidation processing can include adding (i.e., applying) coatings, as in sealers, glazes, paints, functional layers, markings, and/or other surface additives to the part, or a combination of at least one of the foregoing. Types of coatings can include abrasion resistant, adhesive, antimicrobial, catalytic, decorative, electrically or thermally conductive, electrically or thermally non-conductive, light sensitive, non-adhesive, optical, primers, ultra-violet protective, waterproof, or a combination comprising at least one of the foregoing.

Upon completion of post-consolidation processes the composite part can be used in any application where a part having a high strength to weight ratio can be used. These composites can be used in aerospace, automotive, marine, construction, consumer electronics, sports and recreation, medical, prosthetic, and similar industries. For example, these composites can be used in the construction of automotive components, including noise shields, front-end modules, seat structures, instrument-panel carriers, roof racks, bumper beams, knee bolsters, wheel wells, battery trays, trunks/rear storage tubs and door hardware modules, airplane and helicopter components, including seatback trays and supports, seat frames, brackets and supports, airframes, load walls, partitions, floors, storage bins, ceilings, and the like, building components, including brackets, railings, decorative elements, and the like, sporting and recreation goods including, gym equipment, bicycles, golf clubs, racquets, bats, and the like, consumer electronics goods, including notebook computers, tablets, mobile phones, personal data assistants (PDA's), portable MP3 players, personal entertainment devices, and the like, marine components, including frames, masts, railings, storage bins, hatches and the like, medical devices including bone replacements, bone supports, diagnostic devices, joint replacements, medical instruments, orthotics, prosthetics, and the like, and any application where a part having a high strength to weight ratio can be used.

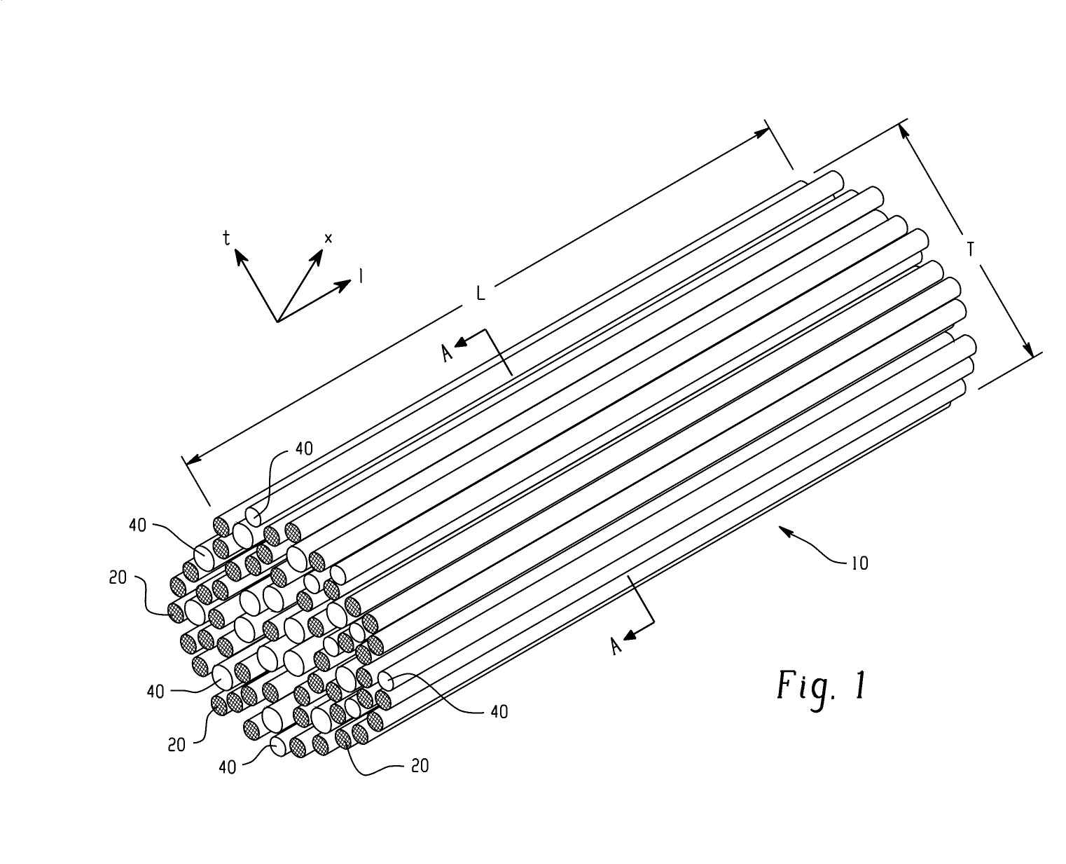

FIG. 1 depicts a commingled yarn tow 10 including reinforcing filaments 20, and thermoplastic resin filaments 40. The filaments can be any shape. The filaments are shown as having a generally cylindrical shape in FIG. 1. The thermoplastic resin filaments 40 are shown having varying sizes (thicknesses, or diameters in this case). The length, L, of the commingled yarn tow 10 can be measured along the 1-axis direction. The thickness of the commingled yarn tow 10, and the individual thicknesses of each filament, can be measured in a t-x plane as the longest line spanning the cross section in any direction within the t-x plane.

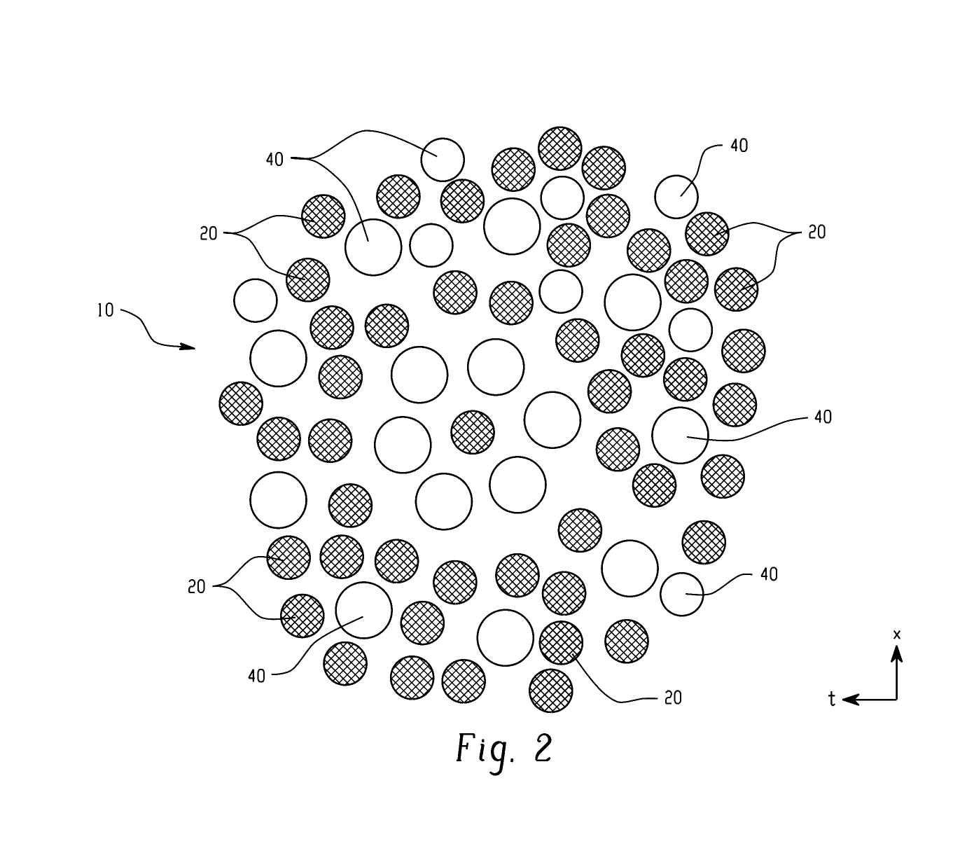

FIG. 2 illustrates the A-A cross section taken in a t-x plane of the commingled yarn tow 10 of FIG. 1. The thermoplastic resin filaments 40 and reinforcing filaments 20 can have any cross-sectional shape. In FIG. 2 the cross-sectional shape of the filaments are circular. The filaments can have varying thicknesses as measured in the t-x plane. The thermoplastic resin filaments 40 can be distributed throughout the cross-sectional area, between reinforcing filaments of the commingled yarn tow 10. The perimeter of the commingled yarn tow 10 can be any shape.

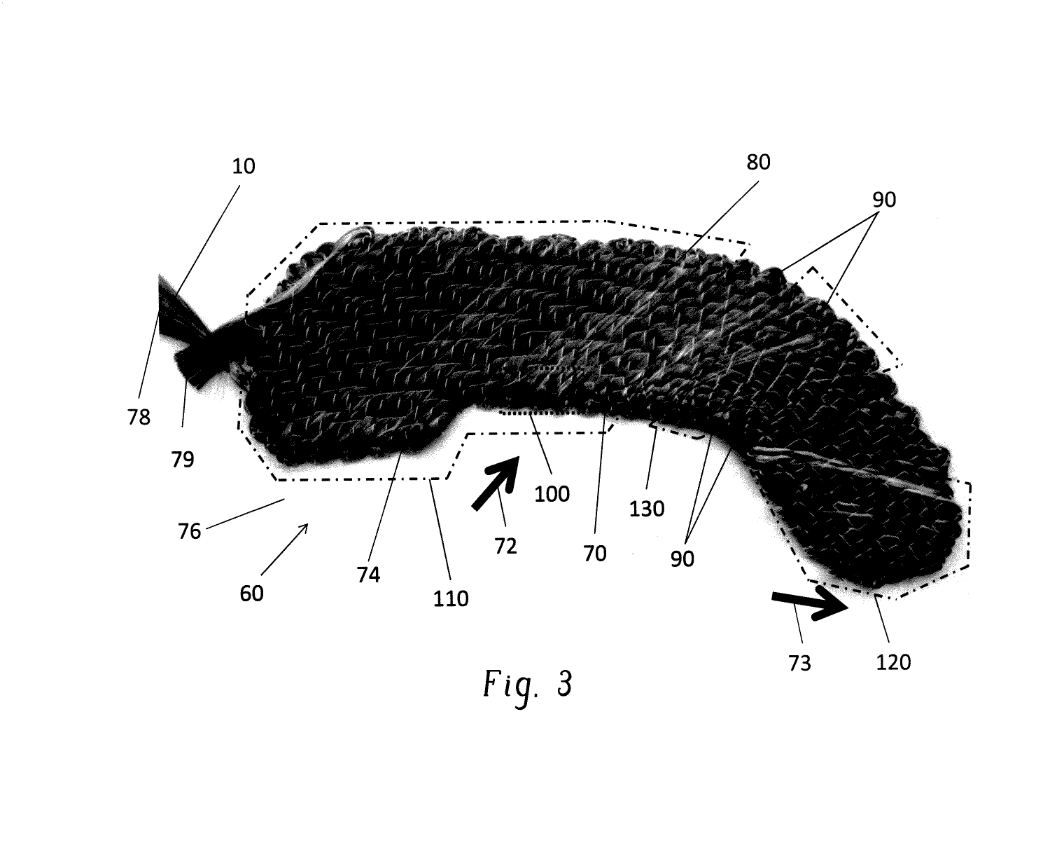

FIG. 3 is a photograph of a TFP preform 60 manufactured using a commingled yarn tow 10. The filaments of the commingled yarn tow 10 can be placed in a specific orientation throughout the TFP preform 60, as can be seen in the parallel orientation of filaments 70 of the commingled yarn tow 10. The commingled yarn tow 10 can be placed substantially continuously throughout the shape of the pattern, across the body 80. The commingled yarn tow 10 can extend parallel to the direction of a steady state force flux (72, 73) which can act in one or more directions within the part when the part is in use (e.g., directions indicated by arrows representing force fluxes 72 and 73). The orientation of the filaments of the commingled yarn tow 10 can change throughout the TFP preform 60. For example, a first portion 110 can have filaments oriented parallel to the direction of a first force flux 72 when the part is in use, a second portion 120 can have filaments oriented parallel to a second force flux 73 when the part is in use. A third portion 130 can have filaments oriented in other directions, such as directions that can intersect the direction of the first force flux 72 or second force flux 73. The commingled yarn tow 10 can be formed into loops 90 as it turns at the edges of body 80. Thermoplastic filaments 74 can attach the commingled yarn tow 10 to a carrier material 76. The thermoplastic filaments 74 can be spaced throughout the TFP preform 60. The commingled yarn tow 10 can be continuous throughout the TFP preform 60 and can have a beginning 78 and an end 79.

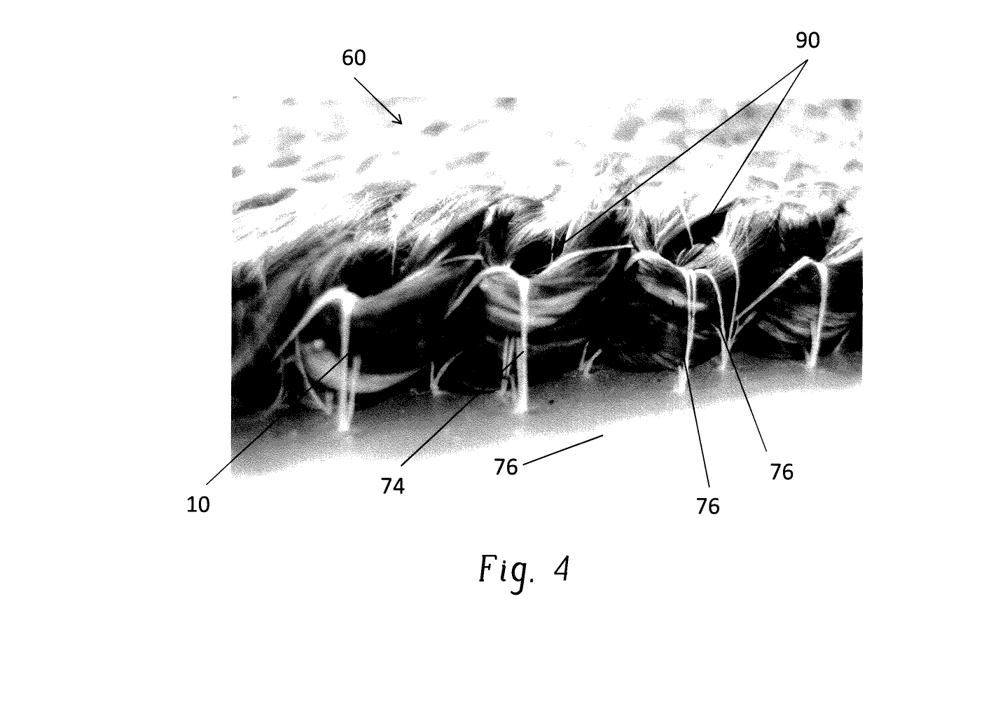

FIG. 4 is a close up of section 100 of the photograph of FIG. 3. Loops 90 can be seen along the edge of the TFP preform 60. Thermoplastic filaments 74 can be seen holding the commingled yarn tow 10 to the carrier layer 76 in the pattern of the TFP preform 60. Groups of thermoplastic resin filaments 40 and reinforcing filaments 20 can are commingled within the commingled yarn tow 10.

Unlike parts produced from other methods the holes do not need to be cut or machined through the reinforcing filament material either prior to consolidation or in a post-consolidation operation from the composite part. Rather holes can be formed by the placement of the commingled yarn tow. The commingled yarn can be attached to the carrier material in a circular pattern, leaving circles of bare carrier material which than can be removed in a subsequent operation without breaking or damaging the reinforcing filaments.

In one example, a commingled yarn preform was attached to a thermoplastic resin carrier material using a stitching machine. The preform was 4 mm thick. The preform was removed from the surrounding carrier material by hand cutting the carrier material along the perimeter edge of the preform. The preform was positioned in a complementarily shaped metal mold. The mold was pressed to 1380 kiloPascal (kPa) (200 pounds per square inch (psi)) and heated to 316° C. (600° F.) and held in this condition. After approximately twenty minutes the mold temperature set point was reduced to 177° C. (350° F.) while the pressure was maintained at 1380 kPa. Once the temperature of the mold had dropped below the glass transition temperature of the thermoplastic resin 214° C. (417° F.) the mold was opened and the part removed. Upon cooling to a room temperature of 22° C. (72° F.) the part was tested for structural integrity (yield strength, ultimate strength, hardness, and modulus testing). The structural test results showed that the part met or exceeded the ultimate strength and modulus results for the same shaped part made from laminating layers of woven reinforcing fabric and layers of thermoplastic material at 371° C. (700° F.) and 1380 kPa for thirty minutes.

### Embodiment 1

A method to form a part, comprising: forming a pattern with a commingled yarn, wherein the commingled yarn comprises thermoplastic resin filaments formed from a thermoplastic material and reinforcing filaments formed from a reinforcing material, and wherein the reinforcing material has a glass transition temperature, or a decomposition temperature, or both, that is higher than a glass transition temperature of the thermoplastic material; attaching the pattern to a carrier material to form a preform; and using the preform to form the part.

### Embodiment 2

The method of Embodiment 1, wherein the commingled yarn consists of thermoplastic resin filaments formed from a thermoplastic material and reinforcing filaments formed of a reinforcing material, wherein the reinforcing material has a glass transition temperature and/or a decomposition temperature that is higher than a glass transition temperature of the thermoplastic material.

### Embodiment 3

The method of any one of Embodiments 1-2, comprising disposing the preform in a mold; and heating the preform to melt the thermoplastic resin filaments and form a thermoplastic resin matrix that wets out the reinforcing filaments, to form a consolidated preform.

### Embodiment 4

The method of Embodiment 3, further comprising holding the preform under a pressure of greater than atmospheric pressure as the thermoplastic resin matrix wets out the reinforcing filaments and as the thermoplastic resin matrix cools.

### Embodiment 5

The method of any of Embodiments 3-4, further comprising inserting the consolidated preform in a mold and injection molding resin over the consolidated preform.

### Embodiment 6

The method of any one of Embodiments 1-2, further comprising stacking two or more preforms, heating the preforms to melt the thermoplastic resin filaments and form a thermoplastic resin matrix that wets out the reinforcing filaments, to form a consolidated stack.

### Embodiment 7

The method of Embodiment 6, further comprising inserting the consolidated stack in a mold and injection molding resin over the consolidated stack.

### Embodiment 8

The method of any one of Embodiments 1-7, wherein the commingled yarn is formed from thermoplastic resin filaments and reinforcing filaments by braiding, twisting, spinning, wrapping, air entangling, mechanically intertwining, or a combination comprising at least one of the foregoing.

### Embodiment 9

The method of any one of Embodiments 1-8, wherein attaching comprises stitching, spot-melting, ultra-sonic welding, heat-staking, adhesive deposition, or a combination comprising at least one of the foregoing.

### Embodiment 10

The method of any one of Embodiments 1-9, wherein attaching comprises holding the commingled yarn in place on the carrier material with a fixing thread stitched to the carrier material.

### Embodiment 11

The method of any one of Embodiments 1-10, further comprising arranging a distribution of thermoplastic filaments and reinforcing filaments in the commingled yarn.

### Embodiment 12

The method of any one of Embodiments 1-11, comprising trimming the carrier material from the preform.

### Embodiment 13

The method of any one of Embodiments 1-12, further comprising forming a hole in the part without damaging the reinforcing filaments.

### Embodiment 14

The method of Embodiment 13, wherein a portion of the reinforcing filaments are disposed tangentially to an edge of the hole, along a perimeter of the hole.

### Embodiment 15

A composite part formed by the method of any one of Embodiments 1-14.

### Embodiment 16

A composite part, comprising: a pattern of reinforcing filaments, wherein, when in use, the part has a force flux, and wherein the reinforcing filaments are aligned with the force flux; and a thermoplastic resin matrix; wherein the reinforcing filaments are formed of a reinforcing material different from a thermoplastic material of the thermoplastic resin matrix, wherein the reinforcing filaments are stiffer and of a higher tensile strength than the thermoplastic resin matrix, and wherein the thermoplastic resin matrix is bonded to the reinforcing filaments.

### Embodiment 17

The composite part of any of Embodiments 15-16, wherein the reinforcing filaments are substantially continuous throughout the part.

### Embodiment 18

The composite part of any one of Embodiments 15-17, comprising a hole therethrough, wherein a portion of the reinforcing filaments are disposed tangentially to an edge of the hole along a perimeter of the hole.

### Embodiment 19

The composite part of any one of Embodiments 16-18, wherein the reinforcing filaments comprise carbon, glass, aramid, basalt, liquid crystal polymer, high tenacity polymer or a combination comprising at least one of the foregoing.

### Embodiment 20

The composite part of any one of Embodiments 15-19, wherein the thermoplastic resin filaments comprise polycarbonates, polypropylenes, polyethylenes, polystyrenes, polyvinyls, polyethylene terephthalates, polybutylene terephthalates, acrylics, nylons, thermoplastic polyurethanes, polyacetals, polyphenylene sulfides, cycloolefin copolymers, thermotropic polyesters, or a combination comprising at least one of the foregoing.

### Embodiment 21

A composite preform comprising: a carrier material; and a commingled yarn; wherein the commingled yarn comprises thermoplastic resin filaments formed from a thermoplastic material and reinforcing filaments formed from a reinforcing material; wherein the reinforcing filaments are stiffer and have a higher tensile strength than the thermoplastic resin filaments; and wherein the commingled yarn is attached to the carrier material in a pattern.

### Embodiment 22

The composite preform of Embodiment 21, wherein the commingled yarn in the pattern is substantially continuous.

### Embodiment 23

The composite preform of any one of Embodiments 21-22 wherein the reinforcing material comprises carbon, glass, aramid, basalt, quartz, boron, cellulose, natural fiber, liquid crystal polymer, high tenacity polymer or a combination comprising at least one of the foregoing.

### Embodiment 24

The composite preform of any one of Embodiments 21-23, wherein the thermoplastic material comprises polycarbonates, polyimides, polyetheretherketone, polyetherketone, polyetherketoneketone, acrylonitrile butadiene styrene, polyoxymethylene, poly(p-phenylene ether), polypropylenes, polyethylenes, polystyrenes, polyvinyls, polyethylene terephthalates, polybutylene terephthalates, acrylics, nylons, thermoplastic polyurethanes, polyacetals, polyphenylene sulfides, cycloolefin copolymers, thermotropic polyesters, or a combination comprising at least one of the foregoing.

### Embodiment 25

The composite preform of any one of Embodiments 21-24, wherein the carrier material comprises a thermoplastic resin, a reinforcing filament, or a combination comprising at least one of the foregoing.

### Embodiment 26

The composite preform of any one of Embodiments 21-25, wherein the carrier material comprises a thermoplastic resin.

### Embodiment 27

The composite preform of any one of Embodiments 21-26, wherein the carrier material comprises a reinforcing filament.

### Embodiment 28

The composite preform of any one of Embodiments 21-27, further comprising a fixing thread, wherein the fixing thread comprises thermoplastic resin filaments, reinforcing filaments, or a combination comprising at least one of the foregoing.

### Embodiment 29

The composite preform of Embodiment 28, wherein the fixing thread comprises thermoplastic resin filaments.

### Embodiment 30

The composite preform of any one of Embodiments 21-29, wherein a thickness of the commingled yarn is 0.1 millimeter to 5 millimeters, wherein the thickness is measured along a longest linear dimension that spans a cross-section of the yarn taken in a t-x plane.

### Embodiment 31

The composite part preform of any one of Embodiments 21-30, wherein the commingled yarn is continuous throughout the preform.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A method to form a part, comprising:
forming a pattern with a commingled yarn, wherein the commingled yarn comprises thermoplastic resin filaments formed from a thermoplastic material and reinforcing filaments formed from a reinforcing material, and wherein the reinforcing material has a glass transition temperature and/or a decomposition temperature that is higher than a glass transition temperature of the thermoplastic material;
attaching the pattern by sewing to a carrier material to form a preform; and
using the preform to form the part,
wherein a thickness of the commingled yarn (10) is 0.1 millimeter to 5 millimeters, wherein the thickness is measured along a longest linear dimension that spans a cross-section of the yarn taken in a t-x plane.

2. The method of claim 1, wherein the commingled yarn consists of thermoplastic resin filaments formed from a thermoplastic material and reinforcing filaments formed of a reinforcing material, wherein the reinforcing material has a glass transition temperature and/or a decomposition temperature that is higher than a glass transition temperature of the thermoplastic material.

3. The method of claim 1, comprising disposing the preform in a mold; and heating the preform to melt the thermoplastic resin filaments and form a thermoplastic resin matrix that wets out the reinforcing filaments, to form a consolidated preform; or further comprising stacking two or more preforms, heating the preforms to melt the thermoplastic resin filaments and form a thermoplastic resin matrix that wets out the reinforcing filaments, to form a consolidated stack.

4. The method of claim 3, further comprising holding the preform under a pressure of greater than atmospheric pressure as the thermoplastic resin matrix wets out the reinforcing filaments and as the thermoplastic resin matrix cools.

5. The method of claim 3, further comprising inserting the consolidated preform in a mold and injection molding resin over the consolidated preform.

6. The method of claim 1, wherein the commingled yarn is formed from thermoplastic resin filaments and reinforcing filaments by braiding, twisting, spinning, wrapping, air entangling, mechanically intertwining, or a combination comprising at least one of the foregoing.

7. The method of claim 1, wherein attaching comprises stitching, spot-melting, ultra-sonic welding, heat-staking, adhesive deposition, or a combination comprising at least one of the foregoing.

8. The method of claim 1, wherein attaching comprises holding the commingled yarn in place on the carrier material with a fixing thread stitched to the carrier material.

9. The method of claim 1, further comprising arranging a distribution of thermoplastic filaments and reinforcing filaments in the commingled yarn.

10. The method of claim 1, further comprising forming a hole in the part without damaging the reinforcing filaments.

11. A composite part formed by the method of claim 1.

12. A composite part, comprising:
a pattern of reinforcing filaments, wherein the part has a force flux during use, and wherein the reinforcing filaments are aligned with the force flux; and
a thermoplastic resin matrix;
wherein the reinforcing filaments are formed of a reinforcing material different from a thermoplastic material of the thermoplastic resin matrix, wherein the reinforcing filaments are stiffer and of a higher tensile strength than the thermoplastic resin matrix, and wherein the thermoplastic resin matrix is bonded to the reinforcing filaments forming a commingled yarn,
wherein a thickness of the commingled yarn (10) is 0.1 millimeter to 5 millimeters, wherein the thickness is measured along a longest linear dimension that spans a cross-section of the commingled yarn (10) taken in a t-x plane.

13. The composite part of claim 12, wherein the reinforcing filaments are substantially continuous throughout the part.

14. The composite part of claim 12, comprising a hole therethrough, wherein a portion of the reinforcing filaments are disposed tangentially to an edge of the hole along a perimeter of the hole.

15. The composite part of claim 12, wherein the thermoplastic resin filaments comprise polycarbonates, polypropylenes, polyethylenes, polystyrenes, polyvinyls, polyethylene terephthalates, polybutylene terephthalates, acrylics, nylons, thermoplastic polyurethanes, polyacetals, polyphenylene sulfides, cycloolefin copolymers, thermotropic polyesters, or a combination comprising at least one of the foregoing.

16. A composite preform comprising:
a carrier material; and
a commingled yarn;
wherein the commingled yarn comprises thermoplastic resin filaments formed from a thermoplastic material and reinforcing filaments formed from a reinforcing material;
wherein the reinforcing filaments are stiffer and have a higher tensile strength than the thermoplastic resin filaments;
wherein the commingled yarn is attached to the carrier material in a pattern; and
wherein a thickness of the commingled yarn is 0.1 millimeter to 5 millimeters, wherein the thickness is measured along a longest linear dimension that spans a cross-section of the yarn taken in a t-x plane.

17. The composite preform of claim 16, wherein the commingled yarn in the pattern is substantially continuous.

18. The composite preform of claim 16, further comprising a fixing thread, wherein the fixing thread comprises thermoplastic resin filaments, reinforcing filaments, or a combination comprising at least one of the foregoing.

19. (canceled)

20. The composite part preform of claim 16, wherein the commingled yarn is continuous throughout the preform.
